(19) United States
(12) Patent Application Publication
(10) Pub. No.: US 2026/0363236 A1
(43) Pub. Date: Nov. 19, 2026

(54) LIQUID CONCENTRATE FORMULATIONS FOR INSECTICIDAL APPLICATIONS

(71) Applicant: Discovery Purchaser Corporation, Wilmington, DE (US)

(72) Inventors: Kyle Denk, Durham, NC (US); Alexander Ko, Durham, NC (US)

(73) Assignee: Discovery Purchaser Corporation, Wilmington, DE (US)

(21) Appl. No.: 19/208,148

(22) Filed: May 14, 2025

(51) Int. Cl. A01N 25/08; A01N 25/02; A01N 25/30; A01N 43/56; A01N 43/88

(52) U.S. Cl. CPC A01N 25/08; A01N 25/02; A01N 25/30; A01N 43/56; A01N 43/88

(57) ABSTRACT

In one aspect, compositions or formulations for insect control are described herein. In some embodiments, a composition or formulation described herein comprises a continuous phase, and an insecticide-carrier complex dispersed in the continuous phase, wherein the insecticide-carrier complex comprises a carrier, a solvent, an active insecticidal ingredient adsorbed to the carrier, and a surfactant disposed on the exterior surface of the carrier.

### FIELD

The technology described herein generally relates to compositions and methods for a dilutable liquid dust formulation comprising a carrier to which active ingredients can be applied, and more particularly to a liquid concentrate formulation comprising a suspended carrier with active ingredients adsorbed thereon dispersed and/or stabilized in a continuous phase.

### BACKGROUND

Insecticides have long been used to control pests, such as insects, both indoors and outdoors and manufacturers have sought ways in which to improve the performance of such insecticides on pest populations. Generally, insecticides are made up of active and inert ingredients and can be applied to pest populations in a variety of formats. Some conventional insecticidal formulations include suspension concentrates, emulsifiable concentrates, and dustable powders.

Bioavailability, surface compatibility, efficacy, residually, ease-of-use, and ease-to-produce are generally all important properties to consider when building a formulation, such as an insecticidal formulation. Many different formulation types exist that can be formulated on a given active ingredient with these different properties derived. Notably, suspension concentrates (SC), emulsifiable concentrates (EC), and dustable powders (DP) are known formulation types designed to address these properties. However, each of these formulation types have pros and cons when compared to one another and are employed for achieving their particular formulation features. For example, EC and DP formulations have good bioavailability and enhanced efficacy, while SC formulations have good surface compatibility and residuality. Additionally, for example, SC and EC formulations have superior ease-of-use and ease-to-produce characteristics not typically seen with DP formulations. Further, DP formulations in particular have been used to control insect populations as they generally have good longevity, bioavailability to passing insects, and insecticidal performance. However, these formulation types each have drawbacks and no one formulation type can achieve each of their desired particular features.

In contrast to conventional formulations, the technology described herein provides for insecticidal compositions, such as a liquid dust concentrate composition or formulation that improves the insecticidal activity and/or performance of incorporated active ingredients, significantly improves the efficacy of the combined composition or solution beyond the additive performance of the individual components alone, and provides improved residuality on complex surfaces.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are generally directed towards insecticidal compositions that are formed as suspensions, dispersions, or solutions, that are suitable for spraying or for dilution with water to form a sprayable preparation. In some aspects, compositions and formulations described herein can achieve up to 100% morality against insects. In some aspects, a composition is formed as an insecticide-carrier complex in a continuous phase. In some aspects, a composition is a liquid dust composition or concentrate. In some aspects, a composition is a dilutable concentrate or dilutable liquid concentrate. In some aspects, a composition is a dust or particulate suspended or dispersed in a liquid concentrate.

In one aspect, a composition or formulation is provided comprising a continuous phase and an insecticide-carrier complex dispersed in the continuous phase, wherein the insecticide-carrier complex comprises: a carrier, a solvent, an active insecticidal ingredient adsorbed to the carrier, and a surfactant disposed on the exterior surface of the carrier. In some instances, the carrier can be present in the composition in an amount of 1-20 wt. %, based on the total weight of the composition. In some instances, the solvent can be present in the composition in an amount of 1-40 wt. %, based on the total weight of the composition. In some instances, the active insecticidal ingredient can be present in the composition in an amount of 0.01-42 wt. %, based on the total weight of the composition. In some instances, the surfactant can be present in the composition in an amount of 0.1-15 wt. %, based on the total weight of the composition. In some instances, the continuous phase is an aqueous continuous phase. In some instances, the active insecticidal ingredient comprises chlorantraniliprole, indoxacarb, tetraniliprole, flupyradifurone, or an essential oil. In some instances, the carrier is precipitated amorphous silica. In some instances, the insecticide-carrier complex is suspended and/or stabilized in the continuous phase.

In another aspect, a composition comprises a first component and a second component, wherein the ratio of the first component to the second component is up to 25 oz./gal. In some instances, the first component comprises a continuous phase and an insecticide-carrier complex dispersed in the continuous phase, wherein the insecticide-carrier complex comprises: a carrier, a solvent, an active insecticidal ingredient adsorbed to the carrier, and a surfactant disposed on the exterior surface of the carrier. In some instances, the second component is a dilution component, for example water.

In another aspect, methods of use, for instance a method for controlling or eradicating insects is provided. In some instances, a method comprises providing a composition or formulation comprising a continuous phase and an insecticide-carrier complex dispersed in the continuous phase, wherein the insecticide-carrier complex comprises: a carrier, a solvent, an active insecticidal ingredient adsorbed to the carrier, and a surfactant disposed on the exterior surface of the carrier, and administering or applying the composition to an area containing insects. In some instances, a method includes diluting the composition. In some aspects, greater than 60%, greater than 80%, and/or up to 100% efficacy, e.g. mortality rate against insects, can be achieved at a time after the administering is carried out.

These and other embodiments are described in greater detail in the detailed description which follows.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different elements, steps, or combinations of steps and/or elements similar to the ones described in this document, in conjunction with other present or future technologies. Moreover, although the terms “step” can be used herein to connote different elements of methods employed, the terms should not be interpreted as implying any particular order among or between various steps disclosed herein unless and except when the order of individual steps is explicitly described.

Embodiments described herein can be understood more readily by reference to the following detailed description, examples, claims, and figures. Elements, systems, apparatus and methods described herein, however, are not limited to the specific embodiments presented in the detailed description, examples, claims, and figures. It should be recognized that these embodiments are merely illustrative of the principles of the present disclosure. Numerous modifications and adaptations will be readily apparent to those of skill in the art without departing from the scope of the disclosure or the technology described herein. Accordingly, this disclosure is not intended to embrace all such alternatives, modifications and variations that fall within the scope of the technology.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, 1 to 4, 3 to 7, 4.7 to 10.0, 3.6 to 7.9, or 5 to 8.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Additionally, in any disclosed embodiment, the terms “substantially,” “approximately,” and “about” may be substituted with “within [a percentage] of” what is specified, where the percentage includes 0.1, 1, 5, and 10 percent.

Further, when the phrase “up to” is used in connection with an amount or quantity, it is to be understood that the amount is at least a detectable amount or quantity (that is, the amount is a non-zero amount). For example, a material present in an amount “up to” a specified amount can be present from a detectable (or non-zero) amount and up to and including the specified amount. In some other aspects, for example, an amount “up to” includes a lower amount of about 0.1.

It is also to be understood that the article “a” or “an” refers to “at least one,” unless the context of a particular use requires otherwise.

In contrast to conventional compositions and/or formulations, the technology described herein provides a new composition and/or formulation type (in some instances, referred to herein as a liquid dust (LD) or liquid dust concentrate) that brings together and achieves the benefits of suspension concentrates (SC), emulsifiable concentrates (EC), and dustable powders (DP) while not being any one in particular. For example, LD formulations described herein deliver the bioavailability and enhanced efficacy properties of EC and DP formulations while also having the surface compatibility and residuality of SC formulations. Further, LD formulations described herein can also offer the ease-of-use and ease-to-produce benefits of SC and EC formulations. Further, in some aspects, the technology described herein enables or allows for reduced rates of active ingredients needed or present in a composition or formulation to achieve equivalent or better efficacy as compared to other formulation types and commercial standards.

At a high level, aspects of the present technology relate to an improved liquid concentrate formulation or composition, which in some instances, integrate aspects of a suspension concentrate (SC), dustable powder (DP), and/or emulsifiable concentrate (EC). In some aspects, formulations or compositions described herein and their use exhibit improved or superior efficacy performance as compared to exiting formulation types (e.g., SC, DP, or EC). In some aspects, a composition or formulation is provided of a liquid concentrate that incorporates a dust particle that in some instances improves the insecticidal (or pest control) activity and performance of one or more active ingredients or components incorporated therein, for example improving contact efficacy. Accordingly, a liquid dust formulation or composition described herein provides for a more efficacious formulation, or enabling of improved contact efficacy and and/or residuality. In some aspects, compositions or formulations described herein enable contact efficacy in active ingredient molecules that otherwise have little to no contact efficacy either alone or in conventional formulation types. Additionally, a liquid dust composition or formulation (i.e. incorporating a dust particle into a liquid concentrate significantly improves the insecticidal (or pest control) activity of the active ingredients in a liquid-sprayed solution, or diluted solution. The incorporation of the physical dust particle improves the bioavailability of the active ingredients to insects or pests that pass through area treated with the composition, in some instances, particularly on complex surfaces such as wood, concrete, and the like.

In some aspects, a composition and/or formulation described herein can exhibit surprising and improved or superior bioavailability, for instance of an active ingredient, as compared to suspension concentrates and other commercial standards.

In some aspects, a composition and/or formulation described herein can exhibit new or improved routes of exposure for certain active ingredients, for example chlorantraniliprole, which, as will be appreciated, does not normally exhibit contact efficacy in other formulation types.

In some aspects, a composition and/or formulation described herein can exhibit improved or superior formulation-substrate compatibility, particularly as compared to emulsifiable concentrates and/or commercial standards.

In some aspects, a composition and/or formulation described herein can exhibit improved or superior ease-to-produce properties, for example active ingredients (AI) can be delivered at desired particle size ranges without the need to reduce or otherwise mechanically change the size of the AI particles. Further, for example, the AI particles can benefit from the already size-selected properties of the carrier to which they can be affixed. Accordingly, LD compositions or formulations can be produced in various particle size ranges without the need for milling, unlike other formulation types, such as SCs.

In some aspects, a composition and/or formulation described herein can exhibit improved or superior residuality, particularly as compared to ECs, SCs, and commercial standards. In some aspects, a composition and/or formulation described herein can exhibit improved or superior efficacy, particularly as compared to commercial standards.

In some aspects, compositions or formulations according to the present technology can reduce the amount of active ingredient(s) (AI) in those compositions or formulations applied or used to control pests. For instance, formulations or compositions described herein enables lower active ingredient application rates which can still achieve up to 100% mortality in desired pests to control.

In some aspects, compositions or formulations according to the present technology can enhance the bioavailability of one or more active ingredients by, for example, enabling and/or increasing their contact efficacy, and further as well as increasing their residuality on tough surfaces and/or substrates.

In some aspects, a composition or formulation described herein can be formulated as a liquid dust (LD). Accordingly, various aspects enable the formation of composition or formulation that has similarities to a dustable powder concentrate that is additionally in an initial liquid matrix, such that the efficacy of the composition or formulation is not diminished by dilution in or with water. As will be appreciated, conventional dustable powders, for example, are generally ready-to-use and can provide good performance, however, because they are not concentrates they do not perform nearly as well when diluted with water and sprayed out.

Without intending to be bound by theory, solubilized active ingredients are more bioavailable than micronized ingredients. In some aspects, as will be appreciated, silica exhibits desiccating properties and in some instances can be considered an insecticide itself. Silica, when combined with insecticides, can result in a product, composition, or formulation that exhibits better efficacy. However, when introduced to water, silica loses its desiccating properties and any performance enhancement in the resulting product is lost. Further, solubilized active ingredients do not perform well on porous substrates. For example, certain substrates or surfaces such as concrete can exert degrading pressure on active ingredients.

Accordingly, in some aspects, compositions and formulations described herein, such as a liquid dust formulation, composition, concentrate, or dilution can provide multiple advantages over conventional or traditional formulation types. For example, solubilized active ingredients that function on porous surfaces can be delivered, and further compositions can be applied to problematic surfaces such as concrete and maintain good residuality. Additionally, efficacy enhancement can be enabled through such compositions (e.g. active ingredients and silica) that is not lost with the addition of water, for instance when dispersed in a continuous aqueous phase or diluted.

### I. Compositions or Formulations for Insect Control

According to aspects of the present technology, compositions or formulations for use as a pesticide and/or insecticide are provided. In some aspects, a composition or formulation is a dilutable concentrate or dilutable liquid concentrate. In some embodiments, a composition or formulation is a liquid dust, or a liquid concentrate comprising a dust particle. In some aspects, a liquid dust comprises a suspended carrier (e.g. particulate) with one or more solubilized, non-water soluble active ingredient(s). In some aspects, a liquid dust composition or formulation comprises a carrier to which active ingredients are applied via a solvent.

Without intending to be bound by theory, liquid concentrate formulations described herein (e.g. a liquid dust concentrate composition) incorporate aspects of suspension concentrates, emulsifiable concentrates, and dustable powders, and enables improved formulation characteristics, for example superior efficacy as compared to conventional formulations or formulation types.

In some embodiments, a composition or formulation comprises an active insecticidal component (or material or ingredient), a carrier or carrier component, a solvent component, and a surfactant component. In some embodiments, compositions or formulations described herein comprise an aqueous phase. In some embodiments, compositions or formulations described herein can be diluted, for example with water.

In some embodiments, a composition comprises a solvent, a carrier, an active ingredient, a surfactant, and a continuous phase. In some aspects, a composition comprises a concentrate or technical concentrate (TK) component and a continuous phase component. In some aspects, a technical concentrate can be added to a continuous phase to form an insecticidal composition concentrate, also referred to herein as a liquid dust concentrate. In some instances, a concentrate composition or liquid dust concentrate can be diluted (e.g. with water). In some aspects, a technical concentrate comprises a solvent, a carrier, and an active ingredient. In some aspects, a continuous phase component can comprise a surfactant and a continuous phase. In some instances, a continuous phase can be another solvent, for example an aqueous solvent such as water. As will be appreciated, other solvents can be used in a continuous phase, or a combination of solvents. In some instances a solvent used for the continuous phase is different than the solvent used for the technical concentrate. In some instances, a continuous phase solvent is immiscible with the technical concentrate solvent.

In some embodiments, an insecticidal composition comprises an insecticide-carrier complex dispersed in a continuous phase, for example a solvent, such as an aqueous solvent. In some aspects, an insecticide-carrier complex comprises a carrier or carrier particle, one or more active insecticidal ingredients, a surfactant, and a solvent. In some aspects, the one or more active insecticidal ingredients are disposed or embedded on and/or within, or are adsorbed to the carrier. In some aspects, the surfactant is disposed on or associated with the exterior surface of the carrier. In some aspects, the surfactant is disposed on the exterior surface of the carrier comprising one or more active insecticidal ingredients. In some aspects, an insecticide-carrier complex is dispersed and/or stabilized in the continuous phase. In some aspects, one or more surfactants do not emulsify with one or more solvents of the composition. In some aspects, the composition is not an emulsion. In some aspects, the composition is a suspension, dispersion, or solution.

In some embodiments, an insecticidal composition comprises an insecticide-carrier complex dispersed in an aqueous continuous phase. In some aspects, an insecticide-carrier complex comprises a carrier or carrier particle, one or more active insecticidal ingredients, and a surfactant.

Turning now in more detail to specific components of compositions and/or formulations described herein, a composition or formulation described herein comprises an active ingredient (e.g. active insecticidal ingredient) or active ingredient component. In some embodiments, a composition or formulation comprises two or more active ingredients. The active ingredient can comprise any active ingredient not inconsistent with the technical objectives of the present disclosure. It is to be understood that an active ingredient component can comprise one or more active ingredients. In some instances, compositions or formulations described herein can be used with various active ingredients with various modes of action, such as sodium channel modulators (e.g., bifenthrin, deltamethrin, alpha-cypermethrin, esfenvalerate, lambda-cyhalothrin, permethrin), nicotinic acetylcholine receptor modulators (e.g., acetamiprid, dinotefuran, clothianidin, imidacloprid, thiamethoxam, flupyradifurone), glutamate gated chlorine channel modulators (e.g., emamectin benzoate, abamectin), sodium channel blockers (e.g., indoxacarb), ryanodine receptor modulators (e.g., chlorantraniliprole, tetraniliprole), oxidative phosphorylation uncouplers (e.g., chlorfenapyr, sulfluramid), and GABA-gated chlorine channel antagonists (e.g., fipronil, ethiprole).

In some aspects, suitable active ingredients can include any active ingredients classified with an Insecticide Resistance Action Committee (IRAC) mode of action classification in classes: IRAC group 2b: Phenylpyrazoles (Fiproles) (e.g. ethiprole, fipronil); IRAC group 3a: Pyrethroids, Pyrethrins (e.g. bifenthrin, cyfluthrin, beta-cyfluthrin, cyhalothrin (lambda and gamma), cypermethrin (alpha, beta, theta, and zeta), deltamethrin, esfenvalerate, amongst others); IRAC group 4a: Neonicotinoids (e.g. acetamiprid, clothianidin, dinotefuran, imidacloprid, amongst others); IRAC group 4d: Butenolides (e.g. flupyradifurone); and IRAC group 6: Avermectins (e.g. abamectin, emamectin benzoate, amongst others).

In some instances, an active ingredient comprises a sodium channel modulator, a nicotinic receptor agonist, a ryanodine receptor modulator, and/or a sodium channel blocker, amongst others. Non-limiting examples of active ingredients that can be used in some embodiments comprise one or more of beta-cyfluthrin, imidacloprid, flupyradifurone, tetraniliprole, chlorantraniliprole, indoxacarb, and/or essential oils or biorationals, amongst others. In some aspects, some non-limiting examples of essential oils include cinnamon oil, clove oil, thyme oil, sesame oil, geraniol, lemongrass oil, castor oil, cedarwood oil, corn oil, cornmint oil, rosemary oil, soybean oil, citronella oil, almond oil, wintergreen oil, cottonseed oil, linseed oil, palm oil, wheat germ oil, 2-Phenyl Ethyl Propionate, amongst other essential oils. In some aspects, a biorational or other naturally derived component may be used, for example a component isolated from one or more essential oils. Some non-limiting examples of biorationals include pyrethrum, spinosad, camphor, benzoic acid derivatives, amongst others.

An active ingredient component of a composition or formulation described herein can be present in the composition in any amount not inconsistent with the technical objectives of the present disclosure. In some embodiments, for example, the active ingredient component is present in an amount or concentration of 0.01-45 wt. %, or 0.01-452 wt. %, based on the total weight of the composition. In some instances, the active ingredient component is present in an amount of 0.01-30 wt. %, 0.01-25 wt. %, 0.01-20 wt. %, 0.01-15 wt. %, 0.01-10 wt. %, 0.01-5 wt. %, 1-15 wt. %, 1-10 wt. %, 1-5 wt. %, up to 45 wt. %, up to 40 wt. %, up to 35 wt. %, up to 30 wt. %, up to 25 wt. %, up to 20 wt. %, up to 15 wt. %, up to 10 wt. %, or up to 5 wt. %, based on the total weight of the composition. In some instances, the active ingredient can be present in an amount of less than 45 wt. %, less than 40 wt. %, less than 35 wt. %, less than 30 wt. %, less than 25 wt. %, less than 20 wt. %, less than 15 wt. %, less than 10 wt. %, or less than 5 wt. %, based on the total weight of the composition.

In some embodiments, a composition or formulation described herein comprises a carrier or carrier component. Any carrier not inconsistent with the technical objectives of the present disclosure may be used in a composition or formulation described herein. In some embodiments, the carrier comprises a silica, silica-based, or silica-derived carrier. In some aspects, the silica is a silica gel (i.e. amorphous silica). In some aspects, the silica is a fumed silica. In some aspects, the silica is a precipitated silica, i.e. the silica gel or amorphous silica is a precipitated silica gel or precipitated amorphous silica. Accordingly, in some aspects, the carrier comprises an amorphous silica, precipitated silica, or a precipitated amorphous silica. In some instances, a carrier can be nanosized, for example nanoparticles can have an average size from 1-100 nanometers (nm). In some instances the carrier can be microsized, for example microparticles can have an average size from 1-100 micrometers (μm). Accordingly, in some instances the carrier or carrier particles can be micronized or nanonized. A carrier or carrier particle can be of any particle size and have any pore size not inconsistent with the technical objectives of the present disclosure. In some other embodiments, the carrier comprises any suitable carrier, such as ground natural minerals, such as kaolins, clays, talc, chalk, quartz, attapulgite, montmorillonite or diatomaceous earth, ground synthetic minerals, such as finely divided silica, alumina and silicates, cristobalite, or zeolite.

A carrier can be present in a composition or formulation described herein in any amount not inconsistent with the technical objectives of the present disclosure. In some embodiments, for example, the carrier can be present in an amount of 1-20 wt. %, 1-15 wt. %, 1-10 wt. %, 0.1-5 wt. %, or 0.5-15 wt. %, based on the total weight of the composition. In some embodiments, for example, the carrier can be present in an amount up to 20 wt. %, up to 15 wt. %, up 10 wt. %, or up to 5 wt. %, based on the total weight of the composition. In some embodiments, for example, the carrier can be present in an amount of less than 20 wt. %, less than 15 wt. %, less than 10 wt. %, or less than 5 wt. %, based on the total weight of the composition.

In some embodiments, a composition or formulation described herein comprises a solvent and/or co-solvent, or solvent component. In some embodiments, a composition can include one or more solvents and/or co-solvents. Any solvent not inconsistent with the technical objectives of the present disclosure may be used in a composition or formulation described herein. In some instances, the solvent is water-immiscible and/or low-volatility. In some aspects, a solvent can be selected to have sufficient solvency for one or more active ingredients, and further cannot be soluble in water.

In some instances, the solvent comprises a pyrrolidone, a dimethyl amide, a carbonate, a lactate, an adipate, a benzoate, and/or a benzyl ester, amongst others. In some instances, the solvent comprises methyl benzoate, butyl benzoate, benzyl acetate, diisopropyl adipate, dibutyl adipate, ethyl hexyl lactate, dimethyl decanamide, propylene carbonate, and/or n-octyl pyrrolidone, amongst others. In some instances, the solvent comprises N,N-dimethylamide, for example, N,N-dimethyloctanamide, N,N-dimethylnonanamide, and/or N,N-dimethyldecanamide. In some instances, the solvent comprises N-Butylpyrrolidone and/or N-Octyl-2-pyrralidone. In some instances, the solvent comprises 1-Octyl-2-pyrrolidone, benzyl benzoate, 2-ethylhexyl lactate, dibutyl isosorbide, cyclohexanone, propylene glycol phenyl ether, and/or propylene glycol, amongst others.

In some embodiments, a solvent, solvent component, or plurality of solvents can be present in a composition or formulation described herein in any amount not inconsistent with the technical objectives of the present disclosure. In some embodiments, for example, a solvent can be present in an amount of 1-40 wt. %, 1-35 wt. %, 1-30 wt. %, 1-25 wt. %, 1-20 wt. %, 1-15 wt. %, or 1-10 wt. %, based on the total weight of the composition. In some embodiments, for example, the carrier can be present in an amount up to 40 wt. %, up to 35 wt. %, up 30 wt. %, up to 25 wt. %, up to 20 wt. %, up to 20 wt. %, or up to 10 wt. %, based on the total weight of the composition. In some embodiments, for example, the carrier can be present in an amount of less than 40 wt. %, less than 35 wt. %, less than 30 wt. %, less than 25 wt. %, less than 20 wt. %, less than 15 wt. %, or less than 10 wt. %, based on the total weight of the composition.

In some embodiments, a composition or formulation described herein comprises a surfactant or surfactant component. In some embodiments, a composition can include one or more surfactants. Any surfactant not inconsistent with the technical objectives of the present disclosure may be used in a composition or formulation described herein. In some aspects, a surfactant can be used to aid solubility of a composition or of components of a composition, and in some cases can be employed to improve homogeneity of the composition. As will be appreciated, a surfactant may be used to lower surface tension and to aid in the application of a composition, for example through spraying. A surfactant can in some instances be selected based on a use or application method of a composition or formulation described herein. For example, a surfactant can be selected and incorporated into a composition to improve solubility of one or more active ingredients, to improve dispersion, to improve stability, amongst other purposes. In some aspects, a surfactant can be incorporated into a composition or formulation to improve stability or dispersion of an insecticide-carrier complex within a continuous phase, such as an aqueous continuous phase. As such, a surfactant can be selected to stabilize a silica suspension in an aqueous continuous phase, and to further help keep a solvent embedded in or associated with the silica.

In some instances, for example, a surfactant comprises a non-ionic, a cationic, an anionic, a zwitterionic (amphoteric), or a semi-polar non-ionic surfactant, and combinations thereof. In some instances, for example, the surfactant comprises a carboxylic acid, a fatty carboxylic acid, a carboxylic acid salt, a fatty carboxylic acid salt, and/or an ester of a carboxylic acid or fatty carboxylic acid, such as polyglyceryl oleate, polyglyceryl stearate, or lecithin. In some instances, the surfactant comprises polyoxyethylene and/or polyoxypropylene of sorbital oleates, block copolymers of polyoxyethylene and polyoxypropylene, tristyrylphenol ethoxylate/propoxylate, polyoxyethylene castor oil, alkoxylated phosphate esters, and combinations and/or derivatives thereof, amongst others. In some aspects, the surfactant comprises a polycarboxylate, such as sodium polycarboxylate, alkylnaphthalene sulfonate, an organomodified trisiloxane, sodium naphthalene sulfonate formaldehyde condensate, and/or trisiloxane PO-EO, amongst others. In some instances, a surfactant of compositions or formulations described herein do not emulsify with a solvent component in the composition or formulation.

In some embodiments, a surfactant or surfactant component (or for example a combination of two or more surfactants) can be present in a composition or formulation in any amount not inconsistent with the technical objectives of the present disclosure. In some embodiments, a surfactant (or combination of surfactants) is present in an amount of 0.1-20 wt. %, 0.1-15 wt. %, 0.1-10 wt. %, 0.1-5 wt. %, 0.5-15 wt. %, 0.5-10 wt. %, 1-10 wt. %, or 1-5 wt. %, based on the total weight of the composition. In some embodiments, a surfactant and/or emulsifier (or combination of two or more surfactants) is present in an amount of up 20 wt. %, up to 15 wt. %, up to 10 wt. %, or up to 5 wt. %, based on the total weight of the composition.

In some embodiments, a composition described herein comprises a continuous phase or continuous phase component. Any continuous phase component not inconsistent with the technical objectives of the present disclosure may be used in a composition or formulation described herein. In some embodiments the continuous phase comprises another solvent, such as an aqueous solvent. In some embodiments, the continuous phase is water. In some embodiments the continuous phase comprises a water-soluble solvent.

In some embodiments, the continuous phase can be present in a composition described herein in any amount not inconsistent with the technical objectives of the present disclosure. In some embodiments, for example, the continuous phase can be present in an amount of 50-95 wt. %, 50-90 wt. %, 60-80 wt. %, 70-80 wt. %, or 75-80 wt. %. In some embodiments, the continuous phase can be present in an amount of up to 95 wt. %, up to 90 wt. %, up to 80 wt. %, or up to 70 wt. %. In some embodiments, the continuous phase can be present in an amount of less than 95 wt. %, less than 90 wt. %, or less than 80 wt. %.

In some embodiments, a composition or formulation described herein can comprise one or more additional components or additive components. Any additional or additive components not inconsistent with the technical objectives of the present disclosure may be used in a composition or formulation described herein. As will be appreciated, according to some aspects, any additional or additive components can be fully miscible in the continuous phase, for example as a co-continuous phase. In some aspects, one or more additional components comprise a biocide, a buffer or stabilizer, an antifoam agent, a rheology modifier, a film forming agent, an antifreeze agent, an adjuvant, a diluent, a fungicide, an herbicide, and/or a fertilizer, amongst others. In some aspects, a composition or formulation described herein comprises a biocide. Any biocide not inconsistent with the technical objectives of the present disclosure may be used. Some non-limiting examples of commercially available biocides include broad-spectrum micro-biocides, commercially available from Lanxess under the trade name KATHON™ CG/ICP; broad-spectrum biocides, commercially available from Arxada under the trade name PROXEL™ GXL; and/or a micro-biocide, algicide, and/or fungicide, commercially available from Thor under the trade name ACTICIDE® L 30. Other commercially available biocides may also be used.

In some aspects, one or more additional components or additives comprise a buffer and/or a stabilizer, for example citric acid anhydrous citric acid. In some aspects, one or more additional components or additives comprise an antifoam agent, for example an emulsion or aqueous emulsion of polydimethylsiloxane. A non-limiting example of a commercially available antifoam agent includes Silcolapse® 426 R from Elkem Silicones. In some aspects, one or more additional components or additives comprise an antifreeze agent, for example propylene glycol, or 1,2-propylene glycol. In some aspects, an antifreeze agent is miscible with a continuous phase of a composition or formulation described herein. In some aspects, one or more additional components or additives comprise a rheology modifier, for example xanthan gum. In some aspects, one or more additional components or additives comprise a film forming agent, a viscosity modifier, a stabilizer, and/or a binding agent, for example a sodium polycarboxylate or a copolymer, such as sodium trimethylpentene/MA copolymer.

In some embodiments, any additional or additive component can be present in a formulation or composition described herein in any amount not inconsistent with the technical objectives of the present disclosure. In some embodiments, for example, an additional or additive component can be present in an amount of 0.01-10 wt. %, 0.01-5 wt. %, 0.01-3 wt. %, 0.01-2 wt. %, 0.01-1 wt. %. In some embodiments, an additional or additive component can be present in an amount of up to 10 wt. %, up to 5 wt. %, up to 2 wt. %, up to 1 wt. %, up to 0.5 wt. %, up to 0.3 wt. %, or up to 0.2 wt. %.

In some aspects, compositions and formulations described herein can have an efficacy against insects of up to 70% mortality rate, of up to 80% mortality rate, of up to 90% mortality, or up to 100% mortality rate. In some aspects, compositions and formulations described herein can have an efficacy against insects of greater than 60% mortality rate, of greater than 70% mortality rate, of greater than 75% mortality rate, of greater than 80% mortality rate, of greater than 85% mortality rate, of greater than 90% mortality rate, or of greater than 95% mortality rate. In some further aspects, a percent mortality as described above can be achieved after 30 mins, 1 hr, 2 hrs, 4, hrs, 24 hrs, 48 hrs, or 72 hrs.

In some embodiments, a composition comprises a diluted composition or a sprayable composition. In some aspects, a composition comprises a first component comprising a composition concentrate, for example a liquid dust concentrate, and a second component. In some aspects, the second component comprises a dilution component. In some aspects, a second component or a dilution component comprises water. In some instances, a composition comprises the first component and the second component where the ratio of the first component to the second component is up to 2 oz./gal, up to 4 oz./gal, up to 6 oz./gal, up to 8 oz./gal, up to 10 oz./gal, up to 15 oz./gal, up to 20 oz./gal., up to 30 oz./gal, or greater In some aspects, a composition or formulation can achieve an efficacy of up to 100% mortality against insects when sprayed at a given dilution rate in accordance with the forgoing ratios.

In some embodiments, a composition, such as a diluted or sprayable composition, can have an application rate of active ingredient(s) (or concentration or dosage) when sprayed out of 0.0001-1000 mg/m², 0.0005-500 mg/m², 0.001-250 mg/m², 0.005-100 mg/m², 0.1-100 mg/m², 1-100 mg/m², 1-50 mg/m², 1-25 mg/m², 1-15 mg/m², or 0.1-10 mg/m², or in some aspects up to 4 mg/m², up to 10 mg/m², up to 20 mg/m², up to 40 mg/m², up to 50 mg/m², or up to 60 mg/m².

In some aspects, compositions and formulations described herein, such as diluted or sprayable compositions can have an efficacy against insects, of up to 70% mortality rate, of up to 80% mortality rate, of up to 90% mortality, or up to 100% mortality rate. In some aspects, compositions and formulations described herein can have an efficacy against insects of greater than 60% mortality rate, of greater than 70% mortality rate, of greater than 75% mortality rate, of greater than 80% mortality rate, of greater than 85% mortality rate, of greater than 90% mortality rate, or of greater than 95% mortality rate. In some further aspects, a percent mortality as described above can be achieved after 30 mins, 1 hr, 2 hrs, 4, hrs, 24 hrs, 48 hrs, or 72 hrs.

### II. Methods

In some embodiments, methods of making or forming a composition and/or formulation are described herein. In some aspects, a composition comprises a solvent, a carrier, an active ingredient, a surfactant, and a continuous phase. As will be appreciated, a liquid dust composition or formulation type/matrix (or for example a liquid dust concentrate) described herein can be implemented with any array of active ingredients or solutions not inconsistent with the technical objectives of the present disclosure.

In some embodiments, methods comprise combining at least one solvent (e.g. a first solvent), at least one carrier, and at least one active ingredient to provide a first mixture. In some instances, the first mixture or component is a technical concentrate (TK). In some instances, methods comprise combining at least one surfactant with continuous phase or continuous phase material (e.g. a second solvent) to provide a second mixture. In some aspects, the second mixture or component is a continuous phase. In some aspects, the first solvent and the second solvent are immiscible. In some instances, methods further comprise adding the first mixture to the second mixture to form a third mixture. In some aspects, the third mixture is a formed composition, formulation, or liquid dust concentrate. The solvent, carrier, active ingredient surfactant, and continuous phase comprise any described above in Section I, in any amounts also described.

Turning now to specific steps of methods, in some embodiments, a method comprises in a first step preparing a technical concentrate (TK) or first mixture comprising at least one solvent (e.g. a first solvent), at least one carrier, and at least one active ingredient. In some example embodiments, the solvent can be a pyrrolidone, a dimethyl amide, a carbonate, a lactate, an adipate, a benzoate, a benzyl ester, or combinations thereof. In some example embodiments, a solvent can be a benzyl acetate, a diisopropyl adipate, an ethyl hexyl lactate, a dimethyl decanamide, a propylene carbonate, an n-octyl pyrrolidone, or combinations thereof. In some example embodiments, the carrier can be a silica, such as a precipitated silica or precipitated amorphous silica. In some example embodiments, the active ingredient can be chlorantraniliprole, indoxacarb, tetraniliprole, flupyradifurone, an essential oil, or combinations thereof.

In some embodiments, a method comprises in a second step preparing a continuous phase (e.g. aqueous continuous phase) comprising at least one surfactant and at least one solvent (e.g. a second solvent) or continuous phase material. In some aspects, the continuous phase or second solvent comprises an aqueous solvent.

In some embodiments, a method comprises in a third step combining the technical concentrate and the continuous phase, for example by adding the technical concentrate to the continuous phase, to form a composition or liquid dust concentrate. In some further embodiments, a composition concentrate or liquid dust concentrate can be diluted, for instance with water.

Combining a solvent, a carrier, and an active ingredient, and/or a surfactant, and a continuous phase, and/or a first and a second mixture (e.g. a technical concentrate and a continuous phase) can be carried out in any manner not inconsistent with the objectives of the present disclosure. For example, in some embodiments, combining comprises mixing or stirring. Mixing or stirring can be carried out at any temperature not inconsistent with the objectives of the present disclosure. In some embodiments, mixing or stirring is carried out at a temperature greater than room temperature. Moreover, mixing or stirring can be carried out for any duration not inconsistent with the objectives of the present disclosure. In some embodiments, for instance, mixing or stirring is carried out for less than about 60 minutes, less than about 30 minutes, or less than about 10 minutes. In some embodiments, mixing or stirring is carried out for a duration between about 1 minute and about 60 minutes, between about 10 minutes and about 50 minutes, or between about 20 minutes and about 40 minutes. Further, in some embodiments, the temperature and duration of mixing or stirring is selected based on the identity of one or more components, for example one or more components in the first mixture and/or one or more components in the second mixture. In some embodiments, mixing or stirring comprises high-shear or low-shear mixing.

In some embodiments, compositions or formulations described herein may be used, for example, to control, eradicate, or prevent insect infestation. In some aspects, compositions or formulations described herein may be used to eradicate or prevent any pests or insects not inconsistent with the objectives of the present disclosure, for example bed bugs, cockroaches, beetles, centipedes, moths, crickets, flies, lice, fleas, ticks, mites, ants, aphids, or nematodes, amongst other insects. Accordingly, aspects of the technology described herein comprises a method for controlling and/or eradicating insects comprising administering a composition or formulation to an area susceptible to or having insects.

In some aspects, compositions or formulations described herein can be diluted, for example with water. Compositions or formulations described herein can be diluted at any mix rate not inconsistent with the technical objectives of the present disclosure, for example up to 2 oz./gal, up to 4 oz./gal, up to 6 oz./gal, up to 8 oz./gal, up to 10 oz./gal, up to 15 oz./gal, up to 20 oz./gal., up to 30 oz./gal, or greater.

In some aspects, the compositions or formulations described herein can be formed into a spray (i.e. sprayable composition), for example a spot treatment spray. In some aspects, compositions or formulations can be provided as a topical application on insects or pests, or be employed as a residual treatment. In some instances, compositions or formulations described herein can be applied to, and have good residuality on surfaces, such as glazed tile, wood, glass, fabric, carpet, and concrete. As will be appreciated, compositions or formulations described herein can also be applied to, and have good residuality on natural surfaces.

In some aspects, a composition, such as a diluted or sprayable composition, can be sprayed out at an application rate of active ingredient(s) (or concentration or dosage) when sprayed out of 0.0001-1000 mg/m², 0.0005-500 mg/m², 0.001-250 mg/m², 0.005-100 mg/m², 0.1-100 mg/m², 1-100 mg/m², 1-50 mg/m², 1-25 mg/m², 1-15 mg/m², or 0.1-10 mg/m², or in some aspects up to 4 mg/m², up to 10 mg/m², up to 20 mg/m², up to 40 mg/m², up to 50 mg/m², or up to 60 mg/m².

In some aspects, compositions and formulations described herein can have an efficacy, for example against insects, of up to 70% mortality rate, of up to 80% mortality rate, of up to 90% mortality, or up to 100% mortality rate. In some aspects, compositions and formulations described herein can have an efficacy against insects of greater than 60% mortality rate, greater than 70% mortality rate, of greater than 75% mortality rate, of greater than 80% mortality rate, of greater than 85% mortality rate, of greater than 90% mortality rate, or of greater than 95% mortality rate. In some further aspects, a percent mortality as described above can be achieved after 30 minutes, 1 hr, 2 hrs 4 hrs, 24 hrs, or 48 hrs.

### Examples

Some embodiments of compositions described herein are further illustrated in the following non-limiting Examples. These Examples illustrate example embodiments and should not be interpreted to encompass the entire breadth of the present disclosure or technology.

The below non-limiting examples illustrate compositions or formulations described herein. The amounts in Table 1 refer to the wt. % of each component of the identified composition, based on the total weight of the composition (% w/w). It is to be understood that all components of a given composition add up to 100 weight percent.

TABLE 1
Example Compositions

| | |
|---|---|
| Component | wt. % |

Example 1

| | |
|---|---|
| Chlorantraniliprole | 0.2 |
| Citric Acid (anhydrous) | 0.02 |
| Sodium Polycarboxylate | 1.1 |
| Kathon CG/ICP | 0.08 |
| Alkylnaphthalene sulfonate | 1.1 |
| Proxel GXL | 0.18 |
| Aqueous emulsion of polydimethylsiloxane | 0.15 |
| Organomodified trisiloxane | 0.5 |
| Precipitated Silica | 9.6 |
| Propylene glycol | 7.87 |
| Xanthan gum | 0.2 |
| N-Butylpyrrolidone | 5 |
| N-Octyl-2-Pyrrolidone | 10 |
| Water | 64 |

Example 2

| | |
|---|---|
| Indoxacarb | 0.582 |
| Citric Acid (anhydrous) | 0.02 |
| Sodium Polycarboxylate | 1.0 |
| Aqueous emulsion of polydimethylsiloxane | 0.15 |
| Organomodified trisiloxane | 0.5 |
| Precipitated Silica | 9.0 |
| Propylene glycol | 8.0 |
| Xanthan gum | 0.22 |
| Alkylnaphthalene sulfonate | 1.0 |
| Acticide L 30 | 0.11 |
| N,N Dimethylamide | 18 |
| Water | 61.418 |

Example 3

| | |
|---|---|
| Chlorantraniliprole | 3.0 |
| Organomodified trisiloxane | 0.5 |
| Citric Acid (anhydrous) | 0.5 |
| N-Butylpyrrolidone | 30 |
| N,N Dimethylamide | 20 |
| Sodium Polycarboxylate | 1.0 |
| Alkylnaphthalene sulfonate | 1.0 |
| Xanthan gum | 0.2 |
| Aqueous emulsion of polydimethylsiloxane | 0.15 |
| Precipitated Silica | 9.0 |
| Water | 34.65 |

Example 4

| | |
|---|---|
| Chlorantraniliprole | 3.0 |
| Citric Acid (anhydrous) | 0.5 |
| N-Butylpyrrolidone | 30 |
| N,N Dimethylamide | 20 |
| Sodium Trimethylpentene/MA coplymer | 1.0 |
| Sodium naphthalene sulphonate formaldehyde condensate | 1.0 |
| Precipitated Silica | 9.0 |
| Silicone Oil Emulsion 30% | 0.15 |
| Trisiloxane PO-EO | 0.5 |
| Xanthan gum | 0.2 |
| Water | 34.65 |

The below non-limiting examples illustrate specific efficacy testing comparative to some other commercial standards. Efficacy experiments were carried out to demonstrate the efficacy of the example compositions identified in Table 1, with respect to comparative commercial standards which are indicated below in Table 2 and Table 3.

With reference to Table 2, a composition or formulation (i.e. diluted formulation) was applied to a surface at the dosage or application rate indicated in Table 2. Insect tested: German cockroach-PCNC; Surface: tile; Exposure 30 minutes; Timing: infested 4 days post treatment. “UTC” stands for untreated control, and “n” is the number of insects loaded. Replications A, B, and C were performed for each treatment.

TABLE 2
Efficacy of Compositions.

| | | Number Living After: | | | | | | |
|---|---|---|---|---|---|---|---|---|
| | | | 1 | 2 | 4 | 24 | 48 | 72 |
| Treatment | Rep | n | hr. | hr. | hr. | hr. | hr. | hr. |
| UTC | A | 5 | 5 | 5 | 5 | 5 | 5 | 5 |
| | B | 5 | 5 | 5 | 5 | 5 | 5 | 5 |
| | C | 5 | 5 | 5 | 5 | 5 | 5 | 5 |
| Acelepryn 1 mg/m2 | A | 5 | 5 | 5 | 5 | 5 | 5 | 5 |
| | B | 5 | 5 | 5 | 5 | 5 | 5 | 5 |
| | C | 5 | 5 | 5 | 5 | 5 | 5 | 5 |
| Acelepryn 10 mg/m2 | A | 5 | 5 | 5 | 5 | 5 | 5 | 5 |
| | B | 5 | 5 | 5 | 5 | 5 | 5 | 5 |
| | C | 5 | 5 | 5 | 5 | 5 | 5 | 5 |
| Acelepryn 50 mg/m2 | A | 5 | 5 | 5 | 5 | 5 | 5 | 5 |
| | B | 5 | 5 | 5 | 5 | 5 | 5 | 5 |
| | C | 5 | 5 | 5 | 5 | 5 | 5 | 5 |
| Example 1 10 mg/m2 | A | 5 | 4 | 2 | 2 | 2 | 2 | 2 |
| | B | 5 | 1 | 0 | 0 | 0 | 0 | 0 |
| | C | 5 | 2 | 1 | 0 | 0 | 0 | 0 |
| Example 3 50 mg/m2 | A | 5 | 3 | 1 | 2 | 0 | 0 | 0 |
| | B | 5 | 3 | 1 | 1 | 0 | 0 | 0 |
| | C | 5 | 5 | 4 | 3 | 1 | 1 | 1 |

With reference to Table 2, superior and surprising efficacy and bioavailability are shown, as indicated by the speed of eradication. As will be appreciated, the mortality rate of insects is indicated. Further, improved efficacy at the indicated time intervals are shown. The findings of Table 2 show that in accordance with some embodiments, an efficacy of greater than 60%, greater than 80%, and/or up to 100% can be achieved.

With reference to Table 3, a formulation (diluted formulation) was applied to a surface at the dosage or application rate indicated in Table 3 at the specified dilutions indicated in Table 3. Insect tested: German cockroach-Pico; Surface: tile; Exposure 30 minutes; Timing: infested 0 days post treatment. “UTC” stands for untreated control, and “n” is the number of insects loaded. Replications A, B, and C were performed for each treatment.

TABLE 3
Efficacy of Compositions.

| | | Number Living After: | | | | | | |
|---|---|---|---|---|---|---|---|---|
| | | | 30 | 1 | 2 | 4 | 24 | 48 |
| Treatment | Rep | n | min. | hr. | hr. | hr. | hr. | hr. |
| UTC | A | 5 | 5 | 5 | 5 | 5 | 5 | 5 |
| | B | 5 | 5 | 5 | 5 | 5 | 5 | 5 |
| | C | 5 | 5 | 5 | 5 | 5 | 5 | 5 |
| Advion WDG 4 mg/m2 | A | 5 | 5 | 5 | 5 | 5 | 4 | 3 |
| (0.066 oz/gal) | B | 5 | 5 | 5 | 5 | 5 | 3 | 2 |
| | C | 5 | 5 | 5 | 5 | 5 | 5 | 4 |
| Advion WDG 20 mg/m2 | A | 5 | 5 | 5 | 5 | 5 | 1 | 0 |
| (0.33 oz/gal) | B | 5 | 5 | 5 | 5 | 5 | 1 | 0 |
| | C | 5 | 5 | 5 | 5 | 5 | 1 | 0 |
| Advion WDG 40 mg/m2 | A | 5 | 5 | 5 | 5 | 5 | 0 | 0 |
| (0.66 oz/gal) | B | 5 | 5 | 5 | 5 | 5 | 1 | 0 |
| | C | 5 | 5 | 5 | 5 | 5 | 1 | 0 |
| Example 2 4 mg/m2 | A | 5 | 5 | 5 | 5 | 5 | 3 | 0 |
| (2.04 oz/gal) | B | 5 | 5 | 5 | 5 | 5 | 5 | 3 |
| | C | 5 | 5 | 5 | 5 | 5 | 5 | 5 |
| Example 2 20 mg/m2 | A | 5 | 2 | 2 | 3 | 3 | 0 | 0 |
| (10.2 oz/gal) | B | 5 | 1 | 1 | 5 | 4 | 0 | 0 |
| | C | 5 | 1 | 1 | 4 | 4 | 1 | 0 |
| Example 2 40 mg/m2 | A | 5 | 1 | 1 | 5 | 4 | 1 | 1 |
| (20.4 oz/gal) | B | 5 | 1 | 1 | 4 | 4 | 0 | 0 |
| | C | 5 | 1 | 1 | 2 | 2 | 0 | 0 |

With reference to Table 2, superior and surprising efficacy and bioavailability are shown, as indicated by the speed of eradication. As will be appreciated, the mortality rate of insects is indicated. Further, improved efficacy at the indicated time intervals are shown. The findings of Table 2 show that in accordance with some embodiments, an efficacy of greater than 60%, greater than 80%, and/or up to 100% can be achieved.

### Additional Example Embodiments

Additional non-limiting example embodiments are provided below.

Embodiment 1. An insecticidal composition comprising a continuous phase; and an insecticide-carrier complex dispersed in the continuous phase, wherein the insecticide-carrier complex comprises: a carrier, a solvent, an active insecticidal ingredient adsorbed to the carrier, and a surfactant disposed on the exterior surface of the carrier.

Embodiment 2. The composition of Embodiment 1, wherein the continuous phase comprises an aqueous solvent.

Embodiment 3. The composition of Embodiment 1 or Embodiment 2, wherein the carrier comprises a particulate carrier.

Embodiment 4. The composition of any of Embodiments 1-3, wherein the particulate carrier comprises amorphous precipitated silica.

Embodiment 5. The composition of any of the preceding embodiments, wherein the solvent is a solvent for the one or more active insecticidal ingredients.

Embodiment 6. The composition of any of the preceding embodiments, wherein the composition is not an emulsion.

Embodiment 7. The composition of any of the preceding embodiments, wherein the continuous phase and the solvent are immiscible.

Embodiment 8. The composition of any of the preceding embodiments, wherein the active insecticidal ingredient is present in the composition in an amount of 0.01-42 wt. %, based on the total weight of the composition.

Embodiment 9. The composition of any of the preceding embodiments, wherein the surfactant is present in the composition in an amount of 0.1-15 wt. %, based on the total weight of the composition.

Embodiment 10. The composition of any of the preceding embodiments, wherein the amorphous precipitated silica component is present in the composition in an amount of 1-20 wt. %, based on the total weight of the composition.

Embodiment 11. The composition of any of the preceding embodiments, wherein the solvent is present in the composition in an amount of 1-40 wt. %, based on the total weight of the composition.

Embodiment 12. The composition of any of the preceding embodiments, wherein the active insecticidal ingredient comprises chlorantraniliprole, indoxacarb, tetraniliprole, flupyradifurone, or an essential oil, or combinations thereof.

Embodiment 13. The composition of any of the preceding embodiments further comprising a buffer, an antifoaming agent, an antifreeze agent, a rheology modifier, a biocide, a film forming agent, or combinations thereof.

Embodiment 14. The composition of any of the preceding embodiments, wherein the solvent comprises a pyrrolidone, a dimethyl amide, a carbonate, a lactate, an adipate, a benzoate, a benzyl ester, or combinations thereof.

Embodiment 15. The composition of any of the preceding embodiments, wherein the surfactant comprises sodium polycarboxylate, alkylnaphthalene sulfonate, an organomodified trisiloxane, sodium naphthalene sulfonate formaldehyde condensate, trisiloxane PO-EO, or combinations thereof.

Embodiment 16. The composition of any of the preceding embodiments, wherein the active insecticidal ingredient comprises chlorantraniliprole, or further consists essentially of chlorantraniliprole.

Embodiment 17. The composition of any of the preceding embodiments, wherein the active insecticidal ingredient comprises indoxacarb, or further consists essentially of indoxacarb.

Embodiment 18. A composition comprising: a first component, the first component being the composition of any of Embodiments 1-15; and a second component, wherein the ratio of the first component to the second component is up to 25 oz./gal.

Embodiment 19. The composition of Embodiment 18, wherein the ratio of the first component to the second component is about 10 oz./gal.

Embodiment 20. The composition of Embodiment 18, wherein the ratio of the first component to the second component is about 2 oz./gal.

Embodiment 21. The composition of any of Embodiments 18-20, wherein the second component is water.

Embodiment 22. A method of controlling or eradicating insects, the method comprising: providing a composition of any of Embodiments 1-21; and administering the composition to an area containing insects.

Embodiment 23. The method of Embodiment 22, wherein the administering comprises spraying the composition.

Embodiment 24. The method of Embodiment 22 or 23, wherein up to 100% mortality rate of insects is achieved at a time period following the administering.

Embodiment 25. The method of Embodiments 22-24, wherein greater than 60%, or greater than 80% mortality rate of insects is achieved at a time period following the administering.

Many different arrangements of the various components and/or steps are described, as well as those not explicitly shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. An insecticidal composition comprising:
a continuous phase; and
an insecticide-carrier complex dispersed in the continuous phase,
wherein the insecticide-carrier complex comprises:
a carrier, the carrier comprising amorphous precipitated silica, and wherein the amorphous precipitated silica is present in the composition in an amount up to 20 wt. %, based on the total weight of the composition,
a solvent, wherein the solvent is present in the composition in an amount of up to 30 wt. %, based on the total weight of the composition,
one or more active insecticidal ingredients adsorbed to the carrier, and
a surfactant disposed on the exterior surface of the carrier,
wherein the composition is a liquid dust concentrate, and wherein the amount of the solvent present in the composition is based on the amount of carrier in the composition.

2. The composition of claim 1, wherein the continuous phase comprises an aqueous solvent.

3. (canceled)

4. (canceled)

5. The composition of claim 1, wherein the solvent is a solvent for the one or more active insecticidal ingredients.

6. The compositions of claim 1, wherein the composition is not an emulsion.

7. The composition of claim 1, wherein the continuous phase and the solvent are immiscible.

8. The composition of claim 1, wherein the active insecticidal ingredient is present in the composition in an amount of 0.01-42 wt. %, based on the total weight of the composition.

9. The composition of claim 1, wherein the surfactant is present in the composition in an amount of 0.1-15 wt. %, based on the total weight of the composition.

10. (canceled)

11. (canceled)

12. The composition of claim 1, wherein the active insecticidal ingredient comprises one or more of chlorantraniliprole, indoxacarb, tetraniliprole, flupyradifurone, and/or an essential oil.

13. The composition of claim 1, further comprising a buffer, an antifoaming agent, an antifreeze agent, a rheology modifier, a biocide, a film forming agent, or combinations thereof.

14. The composition of claim 1, wherein the solvent comprises a pyrrolidone, a dimethyl amide, a carbonate, a lactate, an adipate, a benzoate, a benzyl ester, or combinations thereof.

15. The composition of claim 1, wherein the surfactant comprises sodium polycarboxylate, alkylnaphthalene sulfonate, an organomodified trisiloxane, sodium naphthalene sulfonate formaldehyde condensate, trisiloxane PO-EO, or combinations thereof.

16. The composition of claim 1, wherein the active insecticidal ingredient comprises indoxacarb.

17. The composition of claim 1, wherein the active insecticidal ingredient comprises chlorantraniliprole.

18. A composition comprising:
a first component, the first component being the composition of claim 1; and
a second component, wherein the ratio of the first component to the second component is up to 25 oz./gal.

19. The composition of claim 18, wherein the ratio of the first component to the second component is about 10 oz./gal.

20. The composition of claim 18, wherein the ratio of the first component to the second component is about 2 oz./gal.

21. The composition of claim 1, wherein the one or more active insecticidal ingredients are completely soluble in the solvent.

22. The composition of claim 1, wherein the one or more active insecticidal ingredients are fully adsorbed to the carrier.

23. The composition of claim 1, wherein the one or more active insecticidal ingredients consists of bifenthrin.
